(19) United States
(12) Patent Application Publication
(10) Pub. No.: US 2022/0309812 A1
(43) Pub. Date: Sep. 29, 2022

(54) INFORMATION PROCESSING APPARATUS, INFORMATION PROCESSING SYSTEM, COMPUTER-READABLE NON-TRANSITORY RECORDING MEDIUM STORING INFORMATION PROCESSING PROGRAM, AND INFORMATION PROCESSING METHOD

(71) Applicant: KYOCERA Document Solutions Inc., Osaka-shi (JP)

(72) Inventor: Kosuke HAMAZAKI, Osaka-shi (JP)

(21) Appl. No.: 17/696,124

(22) Filed: Mar. 16, 2022

(30) Foreign Application Priority Data
Mar. 26, 2021 (JP) 2021-052812

(51) Int. Cl. G06V 30/14; G06T 7/73; G06V 30/18; G06V 30/412

(52) U.S. Cl. CPC G06V 30/1448; G06T 7/73; G06V 30/18; G06V 30/412; G06T 2207/30204; G06T 2207/30176

(57) ABSTRACT

An information processing apparatus includes: a marker extracting unit that extracts a marker from image data, and determines a marker position indicating a position of the marker; a character data extracting unit that extracts character data from the image data, and determines a character position indicating a position of the character data; an attribute data setting unit that sets character data, the character position of which has a specific relationship with the marker position, as an attribute of the marker; and a template generating unit that sets an area to be recognized, which is an area as a target of object recognition, on the basis of the marker position, and generates a template file including the marker position, the character data set as the attribute of the marker, and the area to be recognized.

### INCORPORATION BY REFERENCE

This application is based upon, and claims the benefit of priority from, corresponding Japanese Patent Application No. 2021-052812 filed in the Japan Patent Office on Mar. 26, 2021, the entire contents of which are incorporated herein by reference.

### BACKGROUND

### Field of the Invention

The present disclosure relates to an information processing apparatus that generates a template file used to recognize an object from image data of a fixed form document, a computer-readable non-transitory recording medium storing an information processing program, and an information processing method. The present disclosure relates to an information processing system having this information processing apparatus.

### Description of Related Art

An optical character recognition (OCR) process using a template file is known as a method of extracting a variable object (e.g., characters indicating the amount of money for a form, or a check mark in a check box for a check sheet) from image data of a fixed form document such as a form and a check sheet.

When the information processing apparatus executes this template file, an OCR process is executed for a specified area, and a variable object (such as characters indicating the amount of money for a form, and a check mark in a check box for a check sheet) entered in this area is extracted. Thus, the OCR process using the template file is effective for extracting a variable object (such as characters and a check mark) from a fixed form document.

### SUMMARY

An information processing apparatus according to an aspect of the present disclosure includes: a marker extracting unit that extracts a marker from image data, and determines a marker position indicating a position of the marker; a character data extracting unit that extracts character data from the image data, and determines a character position indicating a position of the character data; an attribute data setting unit that sets character data, the character position of which has a specific relationship with the marker position, as an attribute of the marker; and a template generating unit that sets an area to be recognized, which is an area as a target of object recognition, on the basis of the marker position, and generates a template file including the marker position, the character data set as the attribute of the marker, and the area to be recognized.

An information processing system according to an aspect of the present disclosure includes: an information processing apparatus having: a marker extracting unit that extracts a marker from image data, and determines a marker position indicating a position of the marker; a character data extracting unit that extracts character data from the image data, and determines a character position indicating a position of the character data; an attribute data setting unit that sets character data, the character position of which has a specific relationship with the marker position, as an attribute of the marker; and a template generating unit that sets an area to be recognized, which is an area as a target of object recognition, on the basis of the marker position, and generates a template file including the marker position, the character data set as the attribute of the marker, and the area to be recognized; and a template file executing apparatus having a template file executing unit that executes the template file to recognize an object included in the area to be recognized, from other image data with the same layout as the image data.

In a computer-readable non-transitory recording medium storing an information processing program according to an aspect of the present disclosure, the information processing program causes a processor of an information processing apparatus to operate as: a marker extracting unit that extracts a marker from image data, and determines a marker position indicating a position of the marker; a character data extracting unit that extracts character data from the image data, and determines a character position indicating a position of the character data; an attribute data setting unit that sets character data, the character position of which has a specific relationship with the marker position, as an attribute of the marker; and a template generating unit that sets an area to be recognized, which is an area as a target of object recognition, on the basis of the marker position, and generates a template file including the marker position, the character data set as the attribute of the marker, and the area to be recognized.

An information processing method according to an aspect of the present disclosure includes: extracting a marker from image data, and determining a marker position indicating a position of the marker; extracting character data from the image data, and determining a character position indicating a position of the character data; setting character data, the character position of which has a specific relationship with the marker position, as an attribute of the marker; and setting an area to be recognized, which is an area as a target of object recognition, on the basis of the marker position, and generating a template file including the marker position, the character data set as the attribute of the marker, and the area to be recognized.

### BRIEF DESCRIPTION OF THE DRAWINGS

FIG. 1 illustrates an information processing system according to an embodiment of the present disclosure;

FIG. 2 illustrates a configuration of an information processing apparatus;

FIG. 3 illustrates an operation flow of the information processing apparatus;

FIG. 4 illustrates an example of image data of a fixed form document; and

FIG. 5 illustrates an operation flow of an attribute data setting unit.

### DETAILED DESCRIPTION

Hereinafter, an embodiment of the present disclosure will be described with reference to the drawings.

### 1. Information Processing System

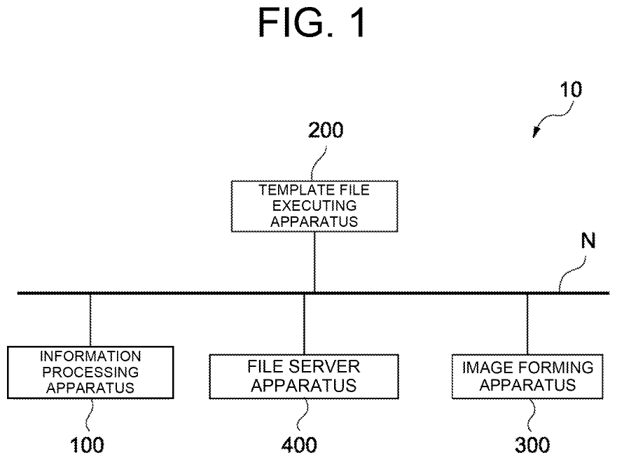

FIG. 1 illustrates an information processing system according to the embodiment of the present disclosure.

An information processing system 10 has an information processing apparatus 100, a template file executing apparatus 200, an image forming apparatus 300, and a file server apparatus 400. The information processing apparatus 100, the template file executing apparatus 200, the image forming apparatus 300, and the file server apparatus 400 are connected to each other via a network N to enable mutual communication. The network N includes the Internet, a LAN (Local Area Network), and the like.

The information processing apparatus 100 and the template file executing apparatus 200 are each a computer in which a processor such as a CPU and a GPU loads an information processing program recorded in a ROM into a RAM and executes the loaded information processing program. The information processing apparatus 100 generates a template file. The template file executing apparatus 200 executes a template file generated by the information processing apparatus 100.

The image forming apparatus 300 is, for example, an MFP (Multifunction Peripheral). The image forming apparatus 300 scans a fixed form document such as a form and a check sheet, generates image data, and transmits the image data to the information processing apparatus 100.

The file server apparatus 400 has a large capacity non-volatile storage apparatus such as an HDD (Hard Disk Drive) and an SSD (Solid State Drive). The file server apparatus 400 stores image data of a fixed form document such as a form and a check sheet, as well as a template file generated by the information processing apparatus 100.

### 2. Configuration of Information Processing Apparatus

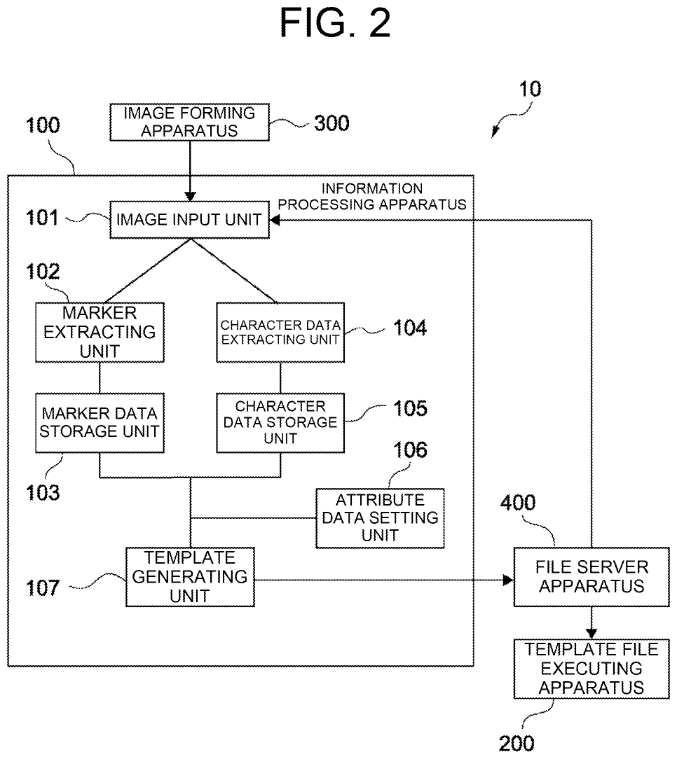

FIG. 2 illustrates a configuration of the information processing apparatus.

The processor such as the CPU and the GPU loads the information processing program recorded in the ROM into the RAM, and executes the information processing program, so that the information processing apparatus 100 operates as an image input unit 101, a marker extracting unit 102, a character data extracting unit 104, an attribute data setting unit 106, and a template generating unit 107. The marker data storage unit 103 and the character data storage unit 105 are set in a storage area of a storage apparatus.

### 3. Operation Flow of Information Processing Apparatus

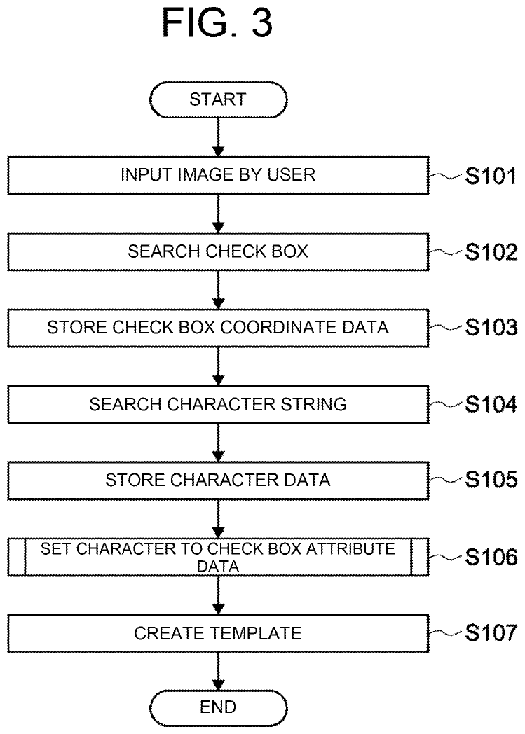

FIG. 3 illustrates an operation flow of an information processing apparatus.

The image input unit 101 acquires image data generated by the image forming apparatus 300 or image data stored by the file server apparatus 400 (Step S101). The image data is image data of a fixed form document such as a form and a check sheet. The image data is scan data generated by optically reading a physical fixed form document, or PDF data obtained by storing printed image of an electronic fixed form document.

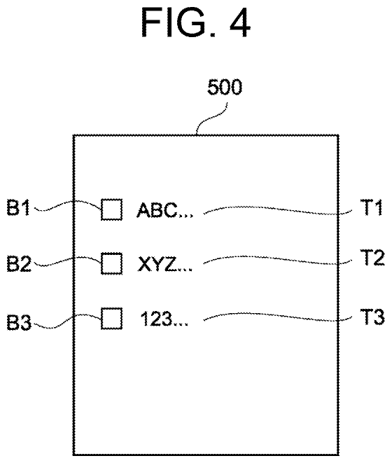

FIG. 4 illustrates an example of image data of the fixed form document.

As an example of image data of the fixed form document, image data 500 of a check sheet is illustrated. The image data 500 of the check sheet includes a plurality of check boxes B1, B2 and B3 and a plurality of character strings T1, T2 and T3.

The marker extracting unit 102 extracts markers from the image data 500 (Step S102). The marker extracting unit 102 has already learned images of the markers to be extracted. The markers are the criteria for setting an area as a target of object recognition (area to be recognized). In this example, the markers are check boxes. That is, the marker extracting unit 102 extracts a plurality of the check boxes B1, B2, and B3 as the markers from the image data 500. The marker extracting unit 102 determines the position of each marker (marker position). The marker position is indicated by coordinates relative to the entire area of the image data 500. That is, the marker extracting unit 102 determines the coordinates of each of the plurality of check boxes B1, B2 and B3 with respect to the entire area of the image data 500 as the marker positions. The marker extracting unit 102 stores the respective marker positions of the plurality of check boxes B1, B2 and B3 in the marker data storage unit 103 (Step S103).

The character data extracting unit 104 extracts character data from the image data 500 by an OCR process (Step S104). The character data extracting unit 104 extracts character data by performing the OCR process for all the character strings included in the image data 500. In this example, the character data extracting unit 104 extracts all the character data T1, T2, and T3 from the image data 500. The character data extracting unit 104 also extracts all the character strings located at positions other than the vicinity of the markers (check boxes) such as a title and a body text. The character data extracting unit 104 determines the position of each extracted character data (character position). The character position is indicated by coordinates relative to the entire area of the image data 500. That is, the character data extracting unit 104 determines the coordinates of each of the plurality of pieces of character data T1, T2 and T3 with respect to the entire area of the image data 500 as the character position. The character data extracting unit 104 stores, in the character data storage unit 105, the respective character positions of the plurality of pieces of character data T1, T2, and T3 in association with of the character data T1, T2 and T3 extracted by the OCR process, respectively (Step S105).

The attribute data setting unit 106 sets the character data, the character position of which has a specific relative positional relationship with the marker position, as the attribute of the marker (Step S106). The attribute data setting unit 106 sets an attribute for each one of the plurality of markers. The specific method is as follows.

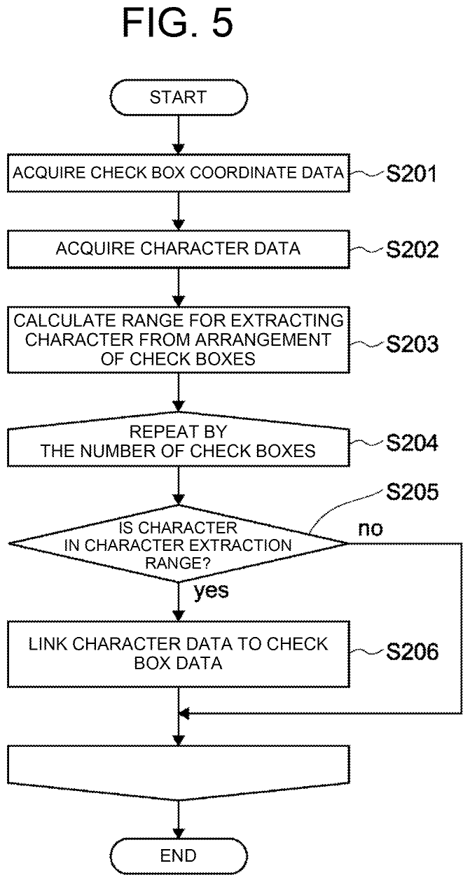

FIG. 5 illustrates an operation flow of the attribute data setting unit.

The attribute data setting unit 106 reads the marker positions (coordinates) of the markers (check boxes B1, B2 and B3) from the marker data storage unit 103 (Step S201). The attribute data setting unit 106 reads the plurality of pieces of character data T1, T2 and T3 and the respective character positions from the character data storage unit 105 (Step S202). The attribute data setting unit 106 determines the character data, the character position of which has a specific relative positional relationship with the marker position, for each of the plurality of markers (check boxes B1, B2 and B3), on the basis of the respective marker positions of the plurality of markers (Step S203). In the case of the example illustrated in FIG. 4, for example, the attribute data setting unit 106 determines the character data T1, the character position of which has the closest relationship with the marker position of the check box B1.

As another example (not illustrated), it is considered that there are a plurality of markers each having a marker position that has a specific relative positional relationship with a character position of the character data. For example, it is assumed that a marker is on the first line, a character string is on the second line a marker is on the third line, a character string is on the fourth line, and the lines are evenly spaced. In this case, the marker on the first line and the marker on the third line are in the same positional relationship relative to the character string on the second line. In this case, the attribute data setting unit 106 determines a marker for which character data is to be set as an attribute, on the basis of the relationship of the marker positions of the plurality of markers. That is, the attribute data setting unit 106 determines a marker for which the character data of the character string on the second line is to be set as the attribute, on the basis of the relationship between the marker position of the marker on the first line and the marker position of the marker on the third line. For example, the attribute data setting unit 106 determines that the marker on the preceding line (the marker on the first line) is set as an attribute of the character data of the character string on the second line.

The attribute data setting unit 106 determines the character data (character data T1, T2 and T3) for which the marker position and character position are in a specific relative positional relationship for each of all markers (check boxes B1, B2 and B3) (Step S204). In this example, the attribute data setting unit 106 determines the character data T1 for the check box B1, determines the character data T2 for the check box B2, and determines the character data T3 for check box B3. The attribute data setting unit 106 does not set the character data whose character position does not have a specific relationship with any marker position as an attribute of any marker (Step S205, no). For example, the attribute data setting unit 106 does not set character data that is in a position other than the vicinity of the marker (check box), such as a title and a body text, as an attribute of any marker.

The attribute data setting unit 106 sets the determined character data as the attribute of the marker (Step S206). In this example, the attribute data setting unit 106 sets the character data T1 as the attribute of the marker B1, sets the character data T2 as the attribute of the marker B2, and sets the character data T3 as the attribute of marker B3.

The template generating unit 107 sets an area as a target of object recognition by an OCR process (area to be recognized) on the basis of the marker positions. Specifically, the area to be recognized is indicated by coordinates relative to the entire area of the image data 500. The area to be recognized is an area in which a variable object is to be entered. In a case where the marker is a check box, the area where the variable object (i.e., the check mark) is to be entered, that is, the area including the check box (i.e., the area inside the check box) is the area to be recognized. In this example, the template generating unit 107 sets the coordinates of an area including the check box B1 as the area to be recognized on the basis of the marker position (coordinates) of the check box B1. The template generating unit 107 associates the marker position of the check box B1 with the character data T1 set as the attribute of the check box B1 (marker) and the area to be recognized (inside the check box B1). The template generating unit 107 associates the marker position of the check box B2 with the character data T2 set as the attribute of the check box B2 (marker) and the area to be recognized (inside the check box B2). The template generating unit 107 associates the marker position of the check box B3 with the character data T3 set as the attribute of the check box B3 (marker) and the area to be recognized (inside the check box B3).

The template generating unit 107 generates a template file that includes the marker positions (coordinates), the pieces of character data set as the attributes of the markers, and the areas to be recognized (coordinates) (Step S107). The template file is written in XML (Extensible Markup Language), for example. The template generating unit 107 stores the generated template file in the file server apparatus 400. The template file is used to recognize the variable objects (i.e., check marks) included in the areas to be recognized (in the check boxes) from other image data with the same layout as the image data 500 of the check sheet by the OCR process.

Thereafter, the template file executing apparatus 200 acquires the template file from the file server apparatus 400, and executes the template file. The template file executing apparatus 200 executes the template file to recognize the variable objects (i.e., the check marks) included in the areas to be recognized (in the check boxes) from other image data with the same layout as the image data 500 of the check sheet by the OCR process.

### 4. Conclusion

An OCR process using a template file is known as a method of extracting a variable object from image data of a fixed form document. In the OCR process using a template file, a template file including an area manually specified by a user is created in advance.

In the OCR process using a template file, there are cases where objects (check marks) entered in many check boxes in a check sheet with many check items are extracted. Compared to a form, a check sheet is likely to be subject to more frequently changes in a document content and layout, such as increase or decrease in check items. For example, in a field where a check sheet is frequently used, such as in the field of education, check sheets with different contents are produced each time, and in a check sheet for collecting real estate information, a large number of check items for various properties such as bath facilities, antennas and lines need to be checked. In the case of such a document, it can be much troubles for a user to manually create a template file every time the document content or layout is changed.

In contrast, according to this embodiment, the information processing apparatus 100 extracts a marker and character data from image data, sets character data as an attribute of the marker on the basis of the relative positional relationship of the marker and character data, and generates a template file including a marker position, character data, and an area to be recognized. Consequently, a use can automatically generate a template file from image data without the need to manually specify the area to be recognized.

Although each embodiment and each modification of the present technology is described above, the present technology is not limited only to the above embodiments, and various changes can be made within the scope without deviating from the gist of the present technology.

What is claimed is:

1. An information processing apparatus comprising:
a marker extracting unit that extracts a marker from image data, and determines a marker position indicating a position of the marker;
a character data extracting unit that extracts character data from the image data, and determines a character position indicating a position of the character data;
an attribute data setting unit that sets character data, the character position of which has a specific relationship with the marker position, as an attribute of the marker; and
a template generating unit that sets an area to be recognized, which is an area as a target of object recognition, on the basis of the marker position, and generates a template file including the marker position, the character data set as the attribute of the marker, and the area to be recognized.

2. The information processing apparatus according to claim 1, wherein the template file is used to recognize an object included in the area to be recognized, from other image data with the same layout as the image data.

3. The information processing apparatus according to claim 1, wherein the marker is a check box, and
the area to be recognized includes the check box.

4. The information processing apparatus according to claim 1, wherein
in a case where there are a plurality of markers each having a marker position that has a specific relationship with the character position of the character data, the attribute data setting unit determines a marker for which the character data is to be set as an attribute, on the basis of the relationships of the marker positions of the plurality of markers.

5. The information processing apparatus according to claim 1, wherein
the image data is image data of a fixed form document.

6. The information processing apparatus according to claim 1, wherein
the template file is written in XML.

7. An information processing system comprising:
an information processing apparatus having:
a marker extracting unit that extracts a marker from image data, and determines a marker position indicating a position of the marker;
a character data extracting unit that extracts character data from the image data, and determines a character position indicating a position of the character data;
an attribute data setting unit that sets character data, the character position of which has a specific relationship with the marker position, as an attribute of the marker; and
a template generating unit that sets an area to be recognized, which is an area as a target of object recognition, on the basis of the marker position, and generates a template file including the marker position, the character data set as the attribute of the marker, and the area to be recognized; and
a template file executing apparatus having a template file executing unit that executes the template file to recognize an object included in the area to be recognized, from other image data with the same layout as the image data.

8. A computer-readable non-transitory recording medium storing an information processing program causing a processor of an information processing apparatus to operate as:
a marker extracting unit that extracts a marker from image data, and determines a marker position indicating a position of the marker;
a character data extracting unit that extracts character data from the image data, and determines a character position indicating a position of the character data;
an attribute data setting unit that sets character data, the character position of which has a specific relationship with the marker position, as an attribute of the marker; and
a template generating unit that sets an area to be recognized, which is an area as a target of object recognition, on the basis of the marker position, and generates a template file including the marker position, the character data set as the attribute of the marker, and the area to be recognized.

9. An information processing method comprising:
extracting a marker from image data, and determining a marker position indicating a position of the marker;
extracting character data from the image data, and determining a character position indicating a position of the character data;
setting character data, the character position of which has a specific relationship with the marker position, as an attribute of the marker; and
setting an area to be recognized, which is an area as a target of object recognition, on the basis of the marker position, and generating a template file including the marker position, the character data set as the attribute of the marker, and the area to be recognized.
